(19) United States
(12) Patent Application Publication
(10) Pub. No.: US 2013/0166882 A1
(43) Pub. Date: Jun. 27, 2013

(54) METHODS AND APPARATUS FOR SCHEDULING INSTRUCTIONS WITHOUT INSTRUCTION DECODE

(71) Applicants: Jack Hilaire CHOQUETTE, Palo Alto, CA (US); Robert J. STOLL, Los Altos, CA (US); Olivier GIROUX, San Jose, CA (US); Michael FETTERMAN, Boxborough, MA (US); Shirish GADRE, Fremont, CA (US); Robert Steven GLANVILLE, Cupertino, CA (US); Alexandre JOLY, Sunnyvale, CA (US)

(72) Inventors: Jack Hilaire CHOQUETTE, Palo Alto, CA (US); Robert J. STOLL, Los Altos, CA (US); Olivier GIROUX, San Jose, CA (US); Michael FETTERMAN, Boxborough, MA (US); Shirish GADRE, Fremont, CA (US); Robert Steven GLANVILLE, Cupertino, CA (US); Alexandre JOLY, Sunnyvale, CA (US)

(21) Appl. No.: 13/335,872

(22) Filed: Dec. 22, 2011

(51) Int. Cl. G06F 9/30; G06F 9/38; G06F 9/312

(52) U.S. Cl. 712/206; 712/E09.016; 712/E09.028; 712/E09.033; 712/E09.045

(57) ABSTRACT

Systems and methods for scheduling instructions without instruction decode. In one embodiment, a multi-core processor includes a scheduling unit in each core for scheduling instructions from two or more threads scheduled for execution on that particular core. As threads are scheduled for execution on the core, instructions from the threads are fetched into a buffer without being decoded. The scheduling unit includes a macro-scheduler unit for performing a priority sort of the two or more threads and a micro-scheduler arbiter for determining the highest order thread that is ready to execute. The macro-scheduler unit and the micro-scheduler arbiter use pre-decode data to implement the scheduling algorithm. The pre-decode data may be generated by decoding only a small portion of the instruction or received along with the instruction. Once the micro-scheduler arbiter has selected an instruction to dispatch to the execution unit, a decode unit fully decodes the instruction.

### BACKGROUND OF THE INVENTION

1. Field of the Invention

The disclosure generally relates to multi-threaded instruction scheduling, and more specifically to methods and apparatus for scheduling instructions without instruction decode.

2. Description of the Related Art

Parallel processors have multiple independent cores that enable multiple threads to be executed simultaneously using different hardware resources. SIMD (single instruction, multiple data) architecture processors execute the same instruction on each of the multiple cores where each core executes on different input data. MIMD (multiple instruction, multiple data) architecture processors execute different instructions on different cores with different input data supplied to each core. Parallel processors may also be multi-threaded, which enables two or more threads to execute substantially simultaneously using the resources of a single processing core (i.e., the different threads are executed on the core during different clock cycles). Instruction scheduling refers to the technique for determining which threads to execute on which cores during the next clock cycle.

Typically, instruction scheduling algorithms will decode a plurality of instructions after fetching the instructions from memory to determine the particular resources required for each specific operation and the latencies associated with those resources. The system may then evaluate the latencies to determine the optimal scheduling order for the plurality of instructions. For example, one instruction may specify an operand (i.e., a register value) that is dependent on a calculation being executed by a previous instruction from the same thread, or an instruction from another thread. If the algorithm determines that the other instruction is currently stalled and waiting for a resource (e.g., performing a memory read to load the value into the register), thereby making the operand unavailable for the next instruction, the algorithm will choose an alternative instruction from a different thread to execute during the next clock cycle while waiting for the resource to become available.

One problem with the above described systems is that decoding a plurality of instructions and analyzing the latencies associated with all of the resources specified by the instructions requires a lot of management resources in the processor and a large amount of state information storage. The processor may determine the specific opcodes specified by the instructions, the resources associated with the operations (e.g., the specific registers passed as operands to each instruction), the interdependencies between instructions, and any other important data associated with the instructions. The implementation of such algorithms may take many clock cycles to complete and a lot of memory for storing and decoding instructions. Fully decoding a plurality of instructions creates inefficiencies in processing and requires additional on-chip hardware resources that increase the cost of such processors.

Accordingly, what is needed in the art is a system and method for performing instruction scheduling without the latency introduced by performing a full instruction decode.

### SUMMARY OF THE INVENTION

One example embodiment of the disclosure sets forth a method for scheduling instructions without instruction decode. The method includes the steps of fetching a plurality of instructions corresponding to two or more thread groups from an instruction cache unit, storing the plurality of instructions in a buffer without decoding the instructions, and receiving pre-decode data associated with each of the instructions. The steps further include selecting an instruction for execution based at least in part on the pre-decode data, decoding the instruction, and dispatching the instruction to the processing unit for execution.

Another example embodiment of the disclosure sets forth a computer-readable storage medium including instructions that, when executed by a processing unit, cause the processing unit to schedule instructions without instruction decode. The instructions cause the processing unit to perform the steps of fetching a plurality of instructions corresponding to two or more thread groups from an instruction cache unit, storing the plurality of instructions in a buffer without decoding the instructions, and receiving pre-decode data associated with each of the instructions. The steps further include selecting an instruction for execution based at least in part on the pre-decode data, decoding the instruction, and dispatching the instruction to the processing unit for execution.

Yet another example embodiment of the disclosure sets forth a system for scheduling instructions without instruction decode that includes a central processing unit and a parallel processing unit. The parallel processing unit includes a scheduling unit configured to fetch a plurality of instructions corresponding to two or more thread groups from an instruction cache unit, store the plurality of instructions in a buffer without decoding the instructions, and receive pre-decode data associated with each of the instructions. The scheduling unit is further configured to select an instruction for execution based at least in part on the pre-decode data, decode the instruction, and dispatch the instruction to the parallel processing unit for execution.

### BRIEF DESCRIPTION OF THE DRAWINGS

So that the manner in which the above recited features of the present disclosure can be understood in detail, a more particular description, briefly summarized above, may be had by reference to example embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram illustrating a computer system configured to implement one or more aspects of the present disclosure;

FIG. 2 is a block diagram of a parallel processing subsystem for the computer system of FIG. 1, according to one embodiment of the present disclosure;

FIG. 3A is a block diagram of the front end of FIG. 2, according to one embodiment of the present disclosure;

FIG. 3B is a block diagram of a general processing cluster within one of the parallel processing units of FIG. 2, according to one embodiment of the present disclosure;

FIG. 3C is a block diagram of a portion of the streaming multiprocessor of FIG. 3B, according to one embodiment of the present disclosure; and

FIG. 4 is a block diagram of the warp scheduler and instruction unit of FIG. 3C, according to one example embodiment of the present disclosure;

FIG. 5A illustrates a cache line fetched from the instruction L1 cache, according to one example embodiment of the present disclosure;

FIG. 5B illustrates the special instruction ss-inst of FIG. 5A, according to one example embodiment of the present disclosure; and

FIG. 6 illustrates a method for scheduling instructions without instruction decode, according to one example embodiment of the present disclosure.

### DETAILED DESCRIPTION

In the following description, numerous specific details are set forth to provide a more thorough understanding of the present invention. However, it will be apparent to one of skill in the art that the present invention may be practiced without one or more of these specific details.

The present disclosure describes systems and methods for scheduling instructions on a processor core prior to decoding the instructions. In one embodiment, a multi-core processor includes a scheduling unit in each core for scheduling instructions from two or more threads on that particular core. As threads are scheduled for execution and received by the processor core, instructions from the threads are fetched from an instruction cache into a buffer without being decoded. The scheduling unit includes a macro-scheduler unit for performing a priority sort of the two or more threads and a micro-scheduler arbiter for determining the highest order thread that is ready to execute. The macro-scheduler unit and the micro-scheduler arbiter use pre-decode data to implement the scheduling algorithm. The pre-decode data may be generated by decoding only a small portion of the instruction. Alternately, the pre-decode data may be received along with the instruction such as embedded in the same cache line as the instruction. Once the micro-scheduler arbiter has selected an instruction to dispatch to the execution unit, a decode unit fully decodes the instruction and stores the decoded values in a register file for execution.

### System Overview

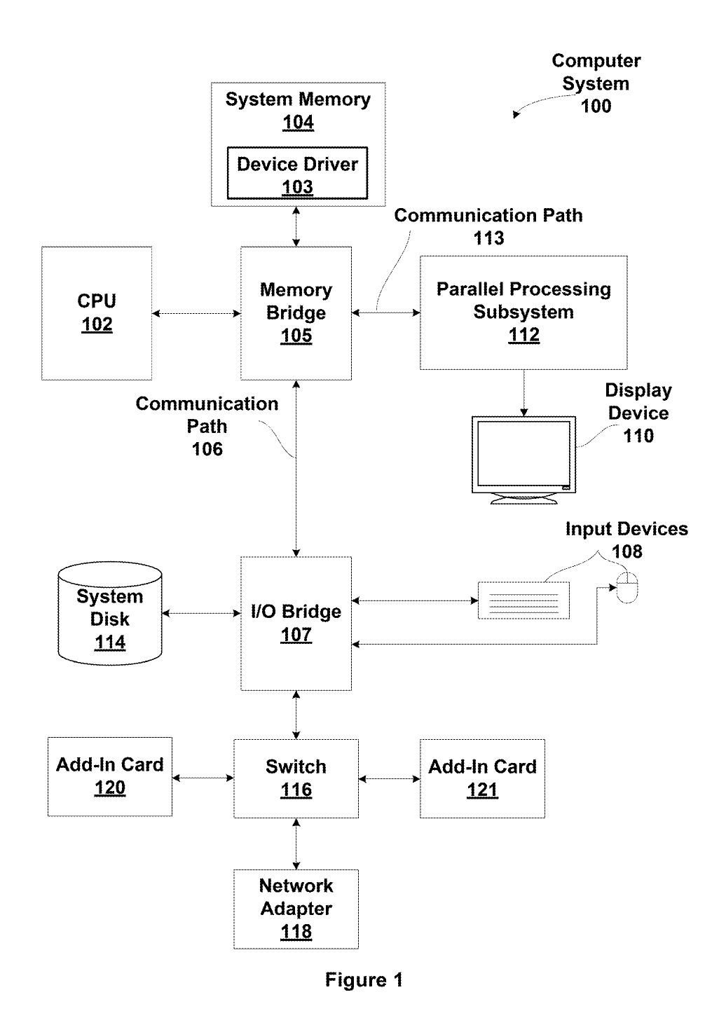

FIG. 1 is a block diagram illustrating a computer system 100 configured to implement one or more aspects of the present disclosure. Computer system 100 includes a central processing unit (CPU) 102 and a system memory 104 communicating via an interconnection path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via communication path 106 and memory bridge 105. A parallel processing subsystem 112 is coupled to memory bridge 105 via a bus or second communication path 113 (e.g., a Peripheral Component Interconnect (PCI) Express, Accelerated Graphics Port, or HyperTransport link); in one embodiment parallel processing subsystem 112 is a graphics subsystem that delivers pixels to a display device 110 (e.g., a conventional cathode ray tube or liquid crystal display based monitor). A system disk 114 is also connected to I/O bridge 107. A switch 116 provides connections between I/O bridge 107 and other components such as a network adapter 118 and various add-in cards 120 and 121. Other components (not explicitly shown), including universal serial bus (USB) or other port connections, compact disc (CD) drives, digital video disc (DVD) drives, film recording devices, and the like, may also be connected to I/O bridge 107. The various communication paths shown in FIG. 1, including the specifically named communications paths 106 and 113, may be implemented using any suitable protocols, such as PCI Express, AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements in a single subsystem, such as joining the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip instead of existing as one or more discrete devices. Large embodiments may include two or more CPUs 102 and two or more parallel processing systems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

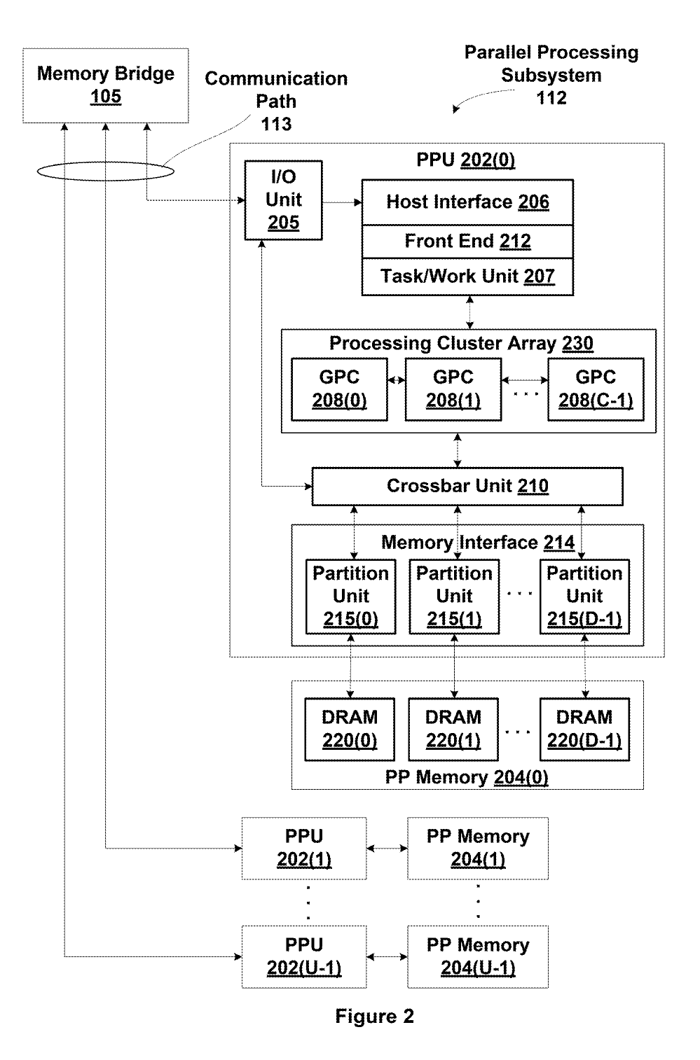

FIG. 2 illustrates a parallel processing subsystem 112, according to one embodiment of the present disclosure. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again to FIG. 1 as well as FIG. 2, in some embodiments, some or all of PPUs 202 in parallel processing subsystem 112 are graphics processors with rendering pipelines that can be configured to perform various operations related to generating pixel data from graphics data supplied by CPU 102 and/or system memory 104 via memory bridge 105 and the second communication path 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have a dedicated parallel processing memory device(s) or no dedicated parallel processing memory device(s). One or more PPUs 202 in parallel processing subsystem 112 may output data to display device 110 or each PPU 202 in parallel processing subsystem 112 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a data structure (not explicitly shown in either FIG. 1 or FIG. 2) that may be located in system memory 104, parallel processing memory 204, or another storage location accessible to both CPU 102 and PPU 202. A pointer to each data structure is written to a pushbuffer to initiate processing of the stream of commands in the data structure. The PPU 202 reads command streams from one or more pushbuffers and then executes commands asynchronously relative to the operation of CPU 102. Execution priorities may be specified for each pushbuffer by an application program via the device driver 103 to control scheduling of the different pushbuffers.

Referring back now to FIG. 2 as well as FIG. 1, each PPU 202 includes an I/O (input/output) unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, some or all elements of PPU 202 may be integrated on a single chip with CPU 102.

In one embodiment, communication path 113 is a PCI Express link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the command stream stored in the pushbuffer to a front end 212.

Each PPU 202 advantageously implements a highly parallel processing architecture. As shown in detail, PPU 202(0) includes a processing cluster array 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary dependent on the workload arising for each type of program or computation.

GPCs 208 receive processing tasks to be executed from a work distribution unit within a task/work unit 207. The work distribution unit receives pointers to processing tasks that are encoded as task metadata (TMD) and stored in memory. The pointers to TMDs are included in the command stream that is stored as a pushbuffer and received by the front end unit 212 from the host interface 206. Processing tasks that may be encoded as TMDs include indices of data to be processed, as well as state parameters and commands defining how the data is to be processed (e.g., what program is to be executed). The task/work unit 207 receives tasks from the front end 212 and ensures that GPCs 208 are configured to a valid state before the processing specified by each one of the TMDs is initiated. A priority may be specified for each TMD that is used to schedule execution of the processing task. Processing tasks can also be received from the processing cluster array 230. Optionally, the TMD can include a parameter that controls whether the TMD is added to the head or the tail for a list of processing tasks (or list of pointers to the processing tasks), thereby providing another level of control over priority.

Memory interface 214 includes a number D of partition units 215 that are each directly coupled to a portion of parallel processing memory 204, where D≧1. As shown, the number of partition units 215 generally equals the number of dynamic random access memory (DRAM) 220. In other embodiments, the number of partition units 215 may not equal the number of memory devices. Persons of ordinary skill in the art will appreciate that DRAM 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 2, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory exclusively or almost exclusively. In UMA embodiments, a PPU 202 may be integrated into a bridge chip or processor chip or provided as a discrete chip with a high-speed link (e.g., PCI Express) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

### Multiple Concurrent Task Scheduling

Multiple processing tasks may be executed concurrently on the GPCs 208 and a processing task may generate one or more “child” processing tasks during execution. The task/work unit 207 receives the tasks and dynamically schedules the processing tasks and child processing tasks for execution by the GPCs 208.

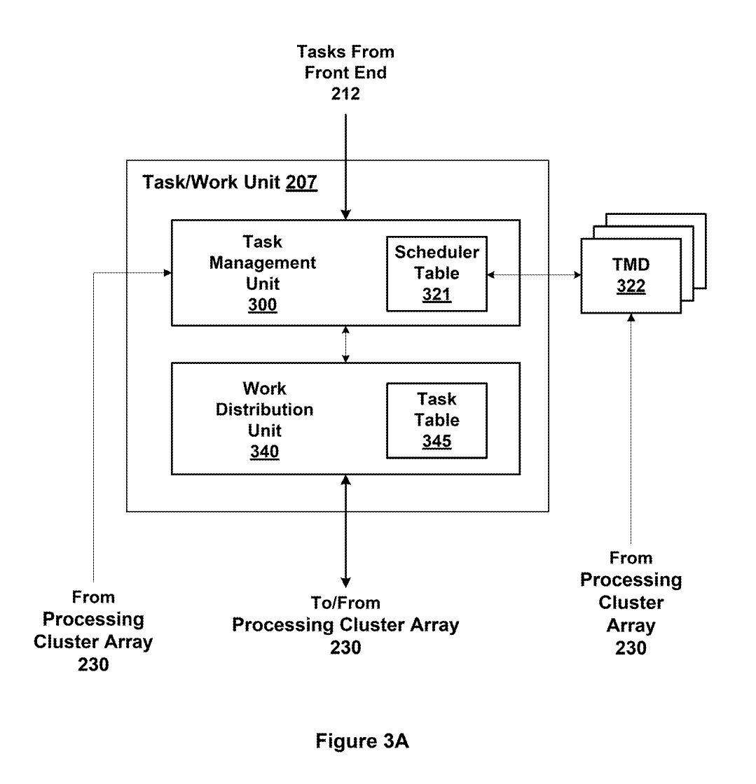

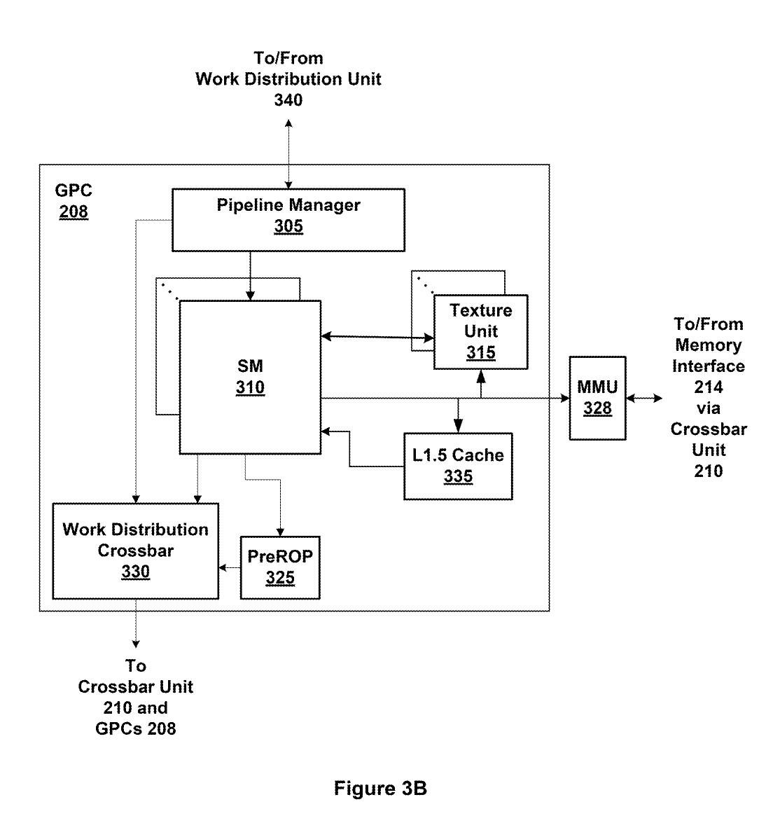

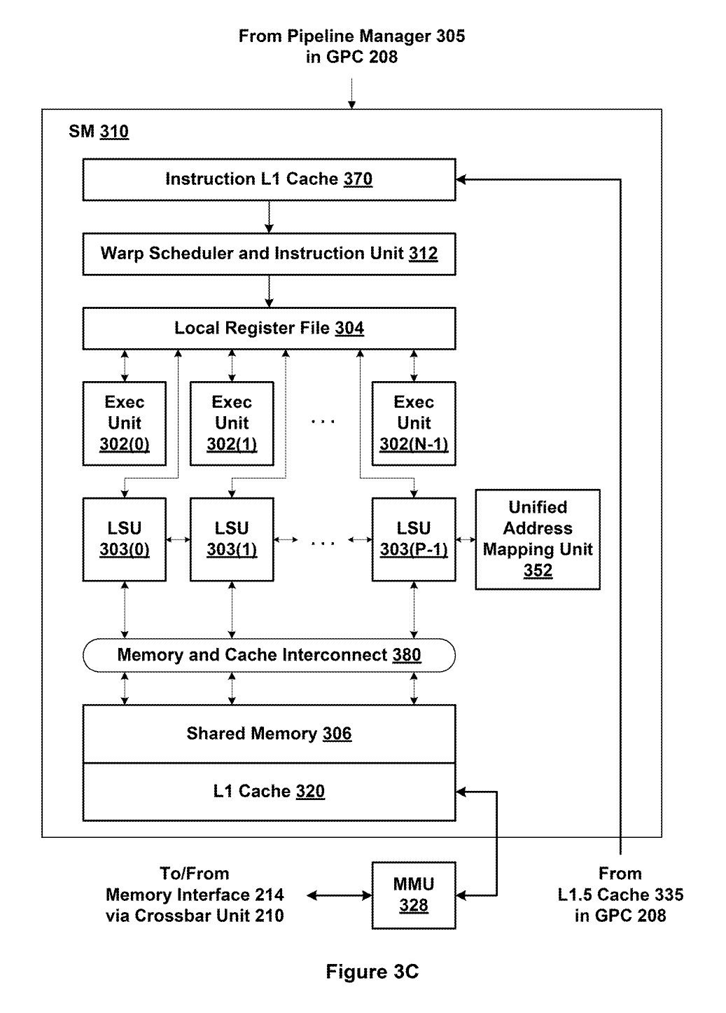

FIG. 3A is a block diagram of the task/work unit 207 of FIG. 2, according to one embodiment of the present disclosure. The task/work unit 207 includes a task management unit 300 and the work distribution unit 340. The task management unit 300 organizes tasks to be scheduled based on execution priority levels. For each priority level, the task management unit 300 stores a list of pointers to the TMDs 322 corresponding to the tasks in the scheduler table 321, where the list may be implemented as a linked list. The TMDs 322 may be stored in the PP memory 204 or system memory 104. The rate at which the task management unit 300 accepts tasks and stores the tasks in the scheduler table 321 is decoupled from the rate at which the task management unit 300 schedules tasks for execution. Therefore, the task management unit 300 may collect several tasks before scheduling the tasks. The collected tasks may then be scheduled based on priority information or using other techniques, such as round-robin scheduling.

The work distribution unit 340 includes a task table 345 with slots that may each be occupied by the TMD 322 for a task that is being executed. The task management unit 300 may schedule tasks for execution when there is a free slot in the task table 345. When there is not a free slot, a higher priority task that does not occupy a slot may evict a lower priority task that does occupy a slot. When a task is evicted, the task is stopped, and if execution of the task is not complete, then a pointer to the task is added to a list of task pointers to be scheduled so that execution of the task will resume at a later time. When a child processing task is generated, during execution of a task, a pointer to the child task is added to the list of task pointers to be scheduled. A child task may be generated by a TMD 322 executing in the processing cluster array 230.

Unlike a task that is received by the task/work unit 207 from the front end 212, child tasks are received from the processing cluster array 230. Child tasks are not inserted into pushbuffers or transmitted to the front end. The CPU 102 is not notified when a child task is generated or data for the child task is stored in memory. Another difference between the tasks that are provided through pushbuffers and child tasks is that the tasks provided through the pushbuffers are defined by the application program whereas the child tasks are dynamically generated during execution of the tasks.

### Task Processing Overview

FIG. 3B is a block diagram of a GPC 208 within one of the PPUs 202 of FIG. 2, according to one embodiment of the present disclosure. Each GPC 208 may be configured to execute a large number of threads in parallel, where the term “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within each one of the GPCs 208. Unlike a SIMD execution regime, where all processing engines typically execute identical instructions, SIMT execution allows different threads to more readily follow divergent execution paths through a given thread program. Persons of ordinary skill in the art will understand that a SIMD processing regime represents a functional subset of a SIMT processing regime.

Operation of GPC 208 is advantageously controlled via a pipeline manager 305 that distributes processing tasks to streaming multiprocessors (SMs) 310. Pipeline manager 305 may also be configured to control a work distribution crossbar 330 by specifying destinations for processed data output by SMs 310.

In one embodiment, each GPC 208 includes a number M of SMs 310, where M≧1, each SM 310 configured to process one or more thread groups. Also, each SM 310 advantageously includes an identical set of functional execution units (e.g., execution units and load-store units—shown as Exec units 302 and LSUs 303 in FIG. 3C) that may be pipelined, allowing a new instruction to be issued before a previous instruction has finished, as is known in the art. Any combination of functional execution units may be provided. In one embodiment, the functional units support a variety of operations including integer and floating point arithmetic (e.g., addition and multiplication), comparison operations, Boolean operations (AND, OR, XOR), bit-shifting, and computation of various algebraic functions (e.g., planar interpolation, trigonometric, exponential, and logarithmic functions, etc.); and the same functional unit hardware can be leveraged to perform different operations.

The series of instructions transmitted to a particular GPC 208 constitutes a thread, as previously defined herein, and the collection of a certain number of concurrently executing threads across the parallel processing engines (not shown) within an SM 310 is referred to herein as a “warp” or “thread group.” As used herein, a “thread group” refers to a group of threads concurrently executing the same program on different input data, with one thread of the group being assigned to a different processing engine within an SM 310. A thread group may include fewer threads than the number of processing engines within the SM 310, in which case some processing engines will be idle during cycles when that thread group is being processed. A thread group may also include more threads than the number of processing engines within the SM 310, in which case processing will take place over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group and is typically an integer multiple of the number of parallel processing engines within the SM 310, and m is the number of thread groups simultaneously active within the SM 310. The size of a CTA is generally determined by the programmer and the amount of hardware resources, such as memory or registers, available to the CTA.

Each SM 310 contains a level one (L1) cache (shown in FIG. 3C) or uses space in a corresponding L1 cache outside of the SM 310 that is used to perform load and store operations. Each SM 310 also has access to level two (L2) caches that are shared among all GPCs 208 and may be used to transfer data between threads. Finally, SMs 310 also have access to off-chip “global” memory, which can include, e.g., parallel processing memory 204 and/or system memory 104. It is to be understood that any memory external to PPU 202 may be used as global memory. Additionally, a level one-point-five (L1.5) cache 335 may be included within the GPC 208, configured to receive and hold data fetched from memory via memory interface 214 requested by SM 310, including instructions, uniform data, and constant data, and provide the requested data to SM 310. Embodiments having multiple SMs 310 in GPC 208 beneficially share common instructions and data cached in L1.5 cache 335.

Each GPC 208 may include a memory management unit (MMU) 328 that is configured to map virtual addresses into physical addresses. In other embodiments, MMU(s) 328 may reside within the memory interface 214. The MMU 328 includes a set of page table entries (PTEs) used to map a virtual address to a physical address of a tile and optionally a cache line index. The MMU 328 may include address translation lookaside buffers (TLB) or caches which may reside within multiprocessor SM 310 or the L1 cache or GPC 208. The physical address is processed to distribute surface data access locality to allow efficient request interleaving among partition units 215. The cache line index may be used to determine whether or not a request for a cache line is a hit or miss.

In graphics and computing applications, a GPC 208 may be configured such that each SM 310 is coupled to a texture unit 315 for performing texture mapping operations, e.g., determining texture sample positions, reading texture data, and filtering the texture data. Texture data is read from an internal texture L1 cache (not shown) or in some embodiments from the L1 cache within SM 310 and is fetched from an L2 cache that is shared between all GPCs 208, parallel processing memory 204, or system memory 104, as needed. Each SM 310 outputs processed tasks to work distribution crossbar 330 in order to provide the processed task to another GPC 208 for further processing or to store the processed task in an L2 cache, parallel processing memory 204, or system memory 104 via crossbar unit 210. A preROP (pre-raster operations) 325 is configured to receive data from SM 310, direct data to ROP units within partition units 215, and perform optimizations for color blending, organize pixel color data, and perform address translations.

It will be appreciated that the core architecture described herein is illustrative and that variations and modifications are possible. Any number of processing units, e.g., SMs 310 or texture units 315, preROPs 325 may be included within a GPC 208. Further, as shown in FIG. 2, a PPU 202 may include any number of GPCs 208 that are advantageously functionally similar to one another so that execution behavior does not depend on which GPC 208 receives a particular processing task. Further, each GPC 208 advantageously operates independently of other GPCs 208 using separate and distinct processing units, L1 caches to execute tasks for one or more application programs.

Persons of ordinary skill in the art will understand that the architecture described in FIGS. 1, 2, 3A, and 3B in no way limits the scope of the present invention and that the techniques taught herein may be implemented on any properly configured processing unit, including, without limitation, one or more CPUs, one or more multi-core CPUs, one or more PPUs 202, one or more GPCs 208, one or more graphics or special purpose processing units, or the like, without departing the scope of the present invention.

In embodiments of the present invention, it is desirable to use PPU 202 or other processor(s) of a computing system to execute general-purpose computations using thread arrays. Each thread in the thread array is assigned a unique thread identifier (“thread ID”) that is accessible to the thread during the thread's execution. The thread ID, which can be defined as a one-dimensional or multi-dimensional numerical value controls various aspects of the thread's processing behavior. For instance, a thread ID may be used to determine which portion of the input data set a thread is to process and/or to determine which portion of an output data set a thread is to produce or write.

A sequence of per-thread instructions may include at least one instruction that defines a cooperative behavior between the representative thread and one or more other threads of the thread array. For example, the sequence of per-thread instructions might include an instruction to suspend execution of operations for the representative thread at a particular point in the sequence until such time as one or more of the other threads reach that particular point, an instruction for the representative thread to store data in a shared memory to which one or more of the other threads have access, an instruction for the representative thread to atomically read and update data stored in a shared memory to which one or more of the other threads have access based on their thread IDs, or the like. The CTA program can also include an instruction to compute an address in the shared memory from which data is to be read, with the address being a function of thread ID. By defining suitable functions and providing synchronization techniques, data can be written to a given location in shared memory by one thread of a CTA and read from that location by a different thread of the same CTA in a predictable manner. Consequently, any desired pattern of data sharing among threads can be supported, and any thread in a CTA can share data with any other thread in the same CTA. The extent, if any, of data sharing among threads of a CTA is determined by the CTA program; thus, it is to be understood that in a particular application that uses CTAs, the threads of a CTA might or might not actually share data with each other, depending on the CTA program, and the terms “CTA” and “thread array” are used synonymously herein.

FIG. 3C is a block diagram of the SM 310 of FIG. 3B, according to one embodiment of the present disclosure. The SM 310 includes an instruction L1 cache 370 that is configured to receive instructions and constants from memory via L1.5 cache 335. A warp scheduler and instruction unit 312 receives instructions and constants from the instruction L1 cache 370 and controls local register file 304 and SM 310 functional units according to the instructions and constants. The SM 310 functional units include N exec (execution or processing) units 302 and P load-store units (LSU) 303.

SM 310 provides on-chip (internal) data storage with different levels of accessibility. Special registers (not shown) are readable but not writeable by LSU 303 and are used to store parameters defining each thread's “position.” In one embodiment, special registers include one register per thread (or per exec unit 302 within SM 310) that stores a thread ID; each thread ID register is accessible only by a respective one of the exec unit 302. Special registers may also include additional registers, readable by all threads that execute the same processing task represented by a TMD 322 (or by all LSUs 303) that store a CTA identifier, the CTA dimensions, the dimensions of a grid to which the CTA belongs (or queue position if the TMD 322 encodes a queue task instead of a grid task), and an identifier of the TMD 322 to which the CTA is assigned.

If the TMD 322 is a grid TMD, execution of the TMD 322 causes a fixed number of CTAs to be launched and executed to process the fixed amount of data stored in the queue 525. The number of CTAs is specified as the product of the grid width, height, and depth. The fixed amount of data may be stored in the TMD 322 or the TMD 322 may store a pointer to the data that will be processed by the CTAs. The TMD 322 also stores a starting address of the program that is executed by the CTAs.

If the TMD 322 is a queue TMD, then a queue feature of the TMD 322 is used, meaning that the amount of data to be processed is not necessarily fixed. Queue entries store data for processing by the CTAs assigned to the TMD 322. The queue entries may also represent a child task that is generated by another TMD 322 during execution of a thread, thereby providing nested parallelism. Typically, execution of the thread, or CTA that includes the thread, is suspended until execution of the child task completes. The queue may be stored in the TMD 322 or separately from the TMD 322, in which case the TMD 322 stores a queue pointer to the queue. Advantageously, data generated by the child task may be written to the queue while the TMD 322 representing the child task is executing. The queue may be implemented as a circular queue so that the total amount of data is not limited to the size of the queue.

CTAs that belong to a grid have implicit grid width, height, and depth parameters indicating the position of the respective CTA within the grid. Special registers are written during initialization in response to commands received via front end 212 from device driver 103 and do not change during execution of a processing task. The front end 212 schedules each processing task for execution. Each CTA is associated with a specific TMD 322 for concurrent execution of one or more tasks. Additionally, a single GPC 208 may execute multiple tasks concurrently.

A parameter memory (not shown) stores runtime parameters (constants) that can be read but not written by any thread within the same CTA (or any LSU 303). In one embodiment, device driver 103 provides parameters to the parameter memory before directing SM 310 to begin execution of a task that uses these parameters. Any thread within any CTA (or any exec unit 302 within SM 310) can access global memory through a memory interface 214. Portions of global memory may be stored in the L1 cache 320.

Local register file 304 is used by each thread as scratch space; each register is allocated for the exclusive use of one thread, and data in any of local register file 304 is accessible only to the thread to which the register is allocated. Local register file 304 can be implemented as a register file that is physically or logically divided into P lanes, each having some number of entries (where each entry might store, e.g., a 32-bit word). One lane is assigned to each of the N exec units 302 and P load-store units LSU 303, and corresponding entries in different lanes can be populated with data for different threads executing the same program to facilitate SIMD execution. Different portions of the lanes can be allocated to different ones of the G concurrent thread groups, so that a given entry in the local register file 304 is accessible only to a particular thread. In one embodiment, certain entries within the local register file 304 are reserved for storing thread identifiers, implementing one of the special registers. Additionally, a uniform L1 cache 375 stores uniform or constant values for each lane of the N exec units 302 and P load-store units LSU 303.

Shared memory 306 is accessible to threads within a single CTA; in other words, any location in shared memory 306 is accessible to any thread within the same CTA (or to any processing engine within SM 310). Shared memory 306 can be implemented as a shared register file or shared on-chip cache memory with an interconnect that allows any processing engine to read from or write to any location in the shared memory. In other embodiments, shared state space might map onto a per-CTA region of off-chip memory, and be cached in L1 cache 320. The parameter memory can be implemented as a designated section within the same shared register file or shared cache memory that implements shared memory 306, or as a separate shared register file or on-chip cache memory to which the LSUs 303 have read-only access. In one embodiment, the area that implements the parameter memory is also used to store the CTA ID and task ID, as well as CTA and grid dimensions or queue position, implementing portions of the special registers. Each LSU 303 in SM 310 is coupled to a unified address mapping unit 352 that converts an address provided for load and store instructions that are specified in a unified memory space into an address in each distinct memory space. Consequently, an instruction may be used to access any of the local, shared, or global memory spaces by specifying an address in the unified memory space.

The L1 cache 320 in each SM 310 can be used to cache private per-thread local data and also per-application global data. In some embodiments, the per-CTA shared data may be cached in the L1 cache 320. The LSUs 303 are coupled to the shared memory 306 and the L1 cache 320 via a memory and cache interconnect 380.

### Instruction Scheduling

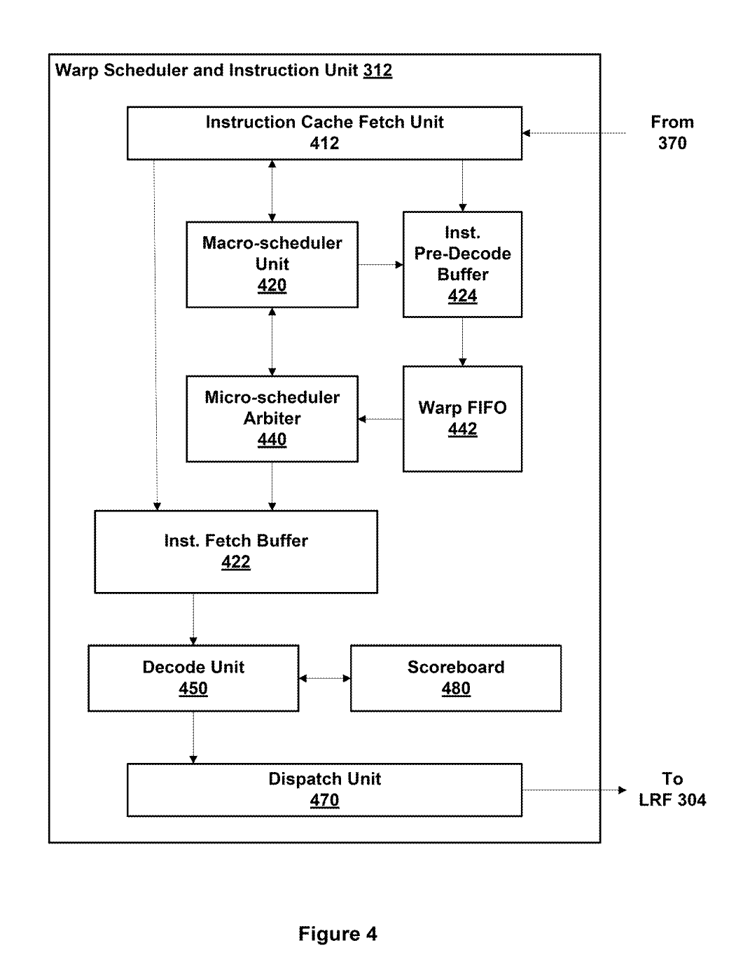

FIG. 4 is a block diagram of the warp scheduler and instruction unit 312 of FIG. 3C, according to one example embodiment of the present disclosure. As shown in FIG. 4, the warp scheduler and instruction unit 312 includes an instruction cache fetch unit 412 that is configured to fetch cache lines containing the instructions for warps from the instruction L1 cache 370. In one embodiment, each cache line is 512 bits wide, storing eight instructions (64 bits wide) in a single cache line. The instruction cache fetch unit 412 routes instructions fetched from the instruction L1 cache 370 to the instruction fetch buffer (IFB) 422 for temporary storage without decoding the instructions. In addition, the instruction cache fetch unit 412 routes pre-decode data associated with the instructions to the instruction pre-decode buffer (IPB) 424 and the macroscheduler unit 420. The pre-decode data may encode a latency value (predetermined by the driver 103) associated with the instruction (e.g., executing this instruction will require 4 clock cycles before the next instruction from the warp may execute) or some other type of data generally helpful with scheduling of instructions.

In one embodiment, the pre-decode data may be generated by decoding only a portion of the instruction (e.g., decoding the first 3 bits of the instruction). It will be appreciated that decoding only this small amount of bits is much more efficient than decoding the entire 64-bit instruction, either in the number of clock cycles required to perform the decode operation or in the amount of physical hardware logic in SM 310. In another embodiment, the pre-decode data may be included as a separate instruction in the cache line. For example, the ISA (instruction set architecture) for the PPU 202 may define a special instruction (ss-inst) that, when decoded by PPU 202 for execution, is the equivalent of a NOP (No Operation Performed) instruction. Driver 103, when compiling a program to produce the machine code for executing various threads on PPU 202, may be configured to write an ss-inst instruction to the beginning of every row of memory (where each row of memory corresponds to the width of the cache line). The ss-inst may include an 8-bit opcode that identifies the instruction as an ss-inst instruction as well as seven 8-bit values that store the pre-decode data for each of the other seven instructions written to the corresponding row of memory. In yet other embodiments, pre-decode data may be passed to the macro-scheduler unit 420 and the IPB 424 by other technically feasible means, such as by writing the pre-decode data to special registers in PPU 202.

In one embodiment, IPB 424 implements a simple read scheduler to ensure that warp FIFO 442 is not empty. In one embodiment, warp FIFO 442 may be implemented as X number of FIFOs that store ss-inst instructions corresponding to each of the warps scheduled to execute on SM 310. IPB 424 enables cache fetches to be performed asynchronously from instruction dispatch to the logical units of SM 310. Macro-scheduler unit 420 maintains a priority associated with each of the warps scheduled on SM 310 and performs a sort of the pre-decode data associated with fetched instructions based on the priorities. For example, macro-scheduler unit 420 may maintain a 6-bit or a 10-bit priority value associated with each of 16 different warps scheduled on SM 310 at any given time. The priority may be assigned based on various factors. In one embodiment, priority may be based on when the warp was scheduled on SM 310 (i.e., the longest pending warp may have the highest priority). In other embodiments, other priority schemes may be adopted, such as by basing priority, at least partially, on scheduling hints determined by the compiler.

In one embodiment, macro-scheduler unit 420 performs a new sort every j number of clock cycles. For example, for 16 warps, macro-scheduler unit 420 may perform a priority sort every 4 clock cycles. In the first clock cycle, macro-scheduler unit 420 may sample the current priority value for each of the 16 pending warps, the starting order of the priorities is based on the previous sort order. In the second clock cycle, macro-scheduler unit 420 compares and swaps warps 0 and 2, warps 1 and 3, warps 4 and 6, . . . , and warps 13 and 15 based on priority values associated with the two warps (with warp 0 corresponding to the highest priority value and warp 15 corresponding to the lowest priority value). In the third clock cycle, macro-scheduler unit 420 compares and swaps warps 0 and 1, warps 2 and 3, warps 4 and 5, . . . , and warps 14 and 15, based on priority value. In the fourth clock cycle, macro-scheduler unit 420 compares and swaps warps 1 and 2, warps 3 and 4, . . . , and warps 13 and 14. The new order based on this priority sort is then used to determine from which warp to dispatch the next instruction by the micro-scheduler arbiter 440.

Micro-scheduler arbiter 440 selects an instruction stored in IFB 422 based on a priority adjustment of the warp order generated by the macro-scheduler unit 420. Micro-scheduler arbiter 440 maintains a state model of SM 310 that is updated based on the issued instructions. The state model allows the micro-scheduler arbiter 440 to adjust the order of priority selected by the macro-scheduler unit 420 based on dynamic execution of the program as it affects the availability of resources within SM 310. For example, the state model may determine that a previously issued instruction from a particular warp requested a value to be read from PP memory 204. The state model may indicate that the value is not yet stored in a register of SM 310. So, if the pre-decode data associated with the next instruction from that particular warp (or a different warp) indicates that the instruction may request that resource (i.e., a register value), then the micro-scheduler arbiter 440 can block execution of that warp and select the next instruction from a lower priority warp instead. Alternatively, the pre-decode data may indicate that the priority of a particular warp should be boosted (or decreased) for a given instruction, thereby causing the instruction associated with a lower priority warp to issue before another instruction from a higher priority warp. Once the micro-scheduler arbiter 440 selects the next instruction to issue, the micro-scheduler arbiter 440 causes the instruction to be routed from the IFB 422 to the decode unit 450. In some embodiments, depending on the architecture of SM 310, instructions may be dual or quad issued, meaning that more than one instruction may be issued and decoded in a particular clock cycle.

Decode unit 450 receives the next instruction to be dispatched from IFB 422. The decode unit 450 performs a full decode of the instruction and transmits the decoded instruction to the dispatch unit 470. Again, in some embodiments, instructions may be dual or quad issued and decode unit 450 may implement separate decode logic for each issued instruction. Dispatch unit 470 implements a FIFO and writes the decoded values to local register file 304 for execution by execution units 302 or load/store units 303. In embodiments that issue multiple instructions simultaneously, dispatch unit 470 may issue each instruction to a different portion of the functional units of SM 310. Scoreboard unit 480 manages and tracks the number of instructions that have been decoded and dispatched per thread group. Although not shown explicitly in FIG. 4, warp scheduler and instruction unit 312 may also include a replay buffer. In some instances, an instruction dispatched by dispatch unit 470 may be rejected by the functional execution units in SM 310. In these instances, instead of re-fetching the instruction and re-decoding the instruction, the decoded instruction may be stored in the replay buffer to be dispatched again at a later clock cycle.

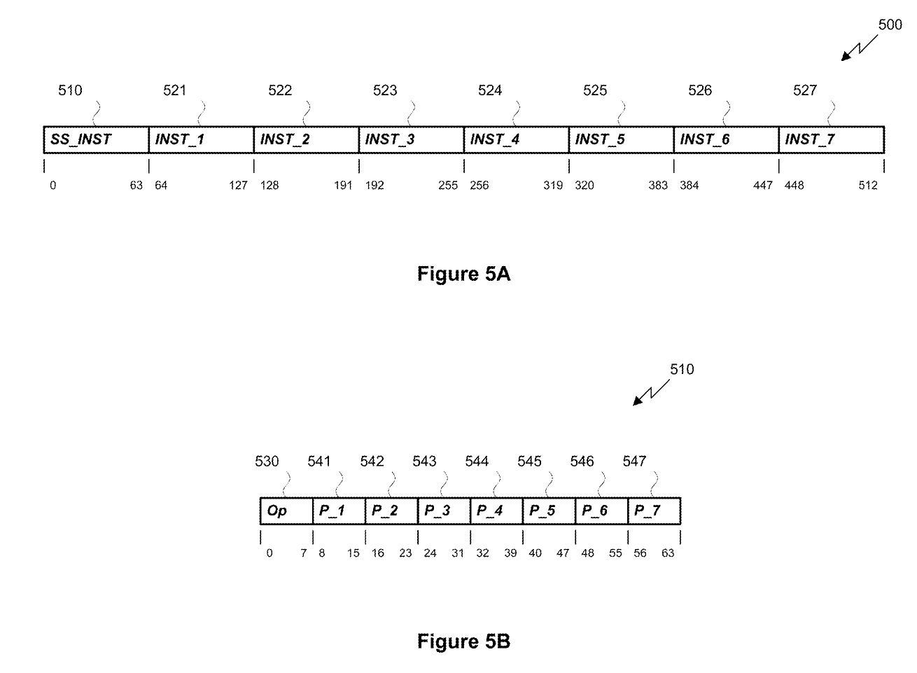

FIG. 5A illustrates a cache line 500 fetched from the instruction L1 cache 370, according to one example embodiment of the present disclosure. As shown, cache line 500 is 512 bits wide and includes eight instructions. Bits 0 through 63 store a special instruction (ss-inst) 510, similar to the instruction described above in FIG. 4, that includes pre-decode data associated with each of the other seven instructions in cache line 500. In addition to the ss-inst 510, bits 64 through 127 of cache line 500 store a first instruction (inst_{—}1) 521, bits 128 through 191 store a second instruction (inst_{—}2) 522, bits 192 through 255 store a third instruction (inst_{—}3) 523, bits 256 through 319 store a fourth instruction (inst_{—}4) 524, bits 320 through 383 store a fifth instruction (inst_{—}5) 525, bits 384 through 447 store a sixth instruction (inst_{—}6) 526, and bits 448 through 512 store a seventh instruction (inst_{—}7) 527. It will be appreciated that the size of cache line 500 may vary in different embodiments. For example, in one embodiment, instructions may be 32-bits wide and cache line 500 may be 256-bits wide. In other embodiments, the amount of pre-decode data may be longer than 8-bits per instruction and, therefore, driver 103 may write two consecutive ss-inst instructions to bits 0 through 128 of cache line 500 and six instructions in bits 128 through 512, where each ss-inst provides pre-decode data for three of the six instructions in the cache line 500.

FIG. 5B illustrates the special instruction ss-inst 510 of FIG. 5A, according to one example embodiment of the present disclosure. As shown in FIG. 5B, ss-inst 510 includes an opcode 530 that is 8-bits wide and stored at bits 0 through 7 of ss-inst 510. The ss-inst 510 instruction also includes pre-decode data for seven instructions associated with ss-inst 510. A first set of pre-decode data (P_{—}1) 541 is stored at bits 8 through 15, a second set of pre-decode data (P_{—}2) 542 is stored at bits 16 through 23, a third set of pre-decode data (P_{—}3) 543 is stored at bits 24 though 31, a fourth set of pre-decode data (P_{—}4) 544 is stored at bits 32 through 39, a fifth set of pre-decode data (P_{—}5) 545 is stored at bits 40 through 47, a sixth set of pre-decode data (P_{—}6) 546 is stored at bits 48 through 55, and a seventh set of pre-decode data (P_{—}7) 547 is stored at bits 56 through 63. As discussed briefly above, pre-decode data 541-547 may encode one or more values associated with scheduling information for a corresponding instruction. For example, the pre-decode data may encode a latency value with four bits (i.e., a value between 0 and 15) and a special scheduling hint with the other four bits, such as a code that indicates to the warp scheduler and instruction unit 312 that no additional instructions from the same warp should be issued after the corresponding instruction for at least 8 clock cycles.

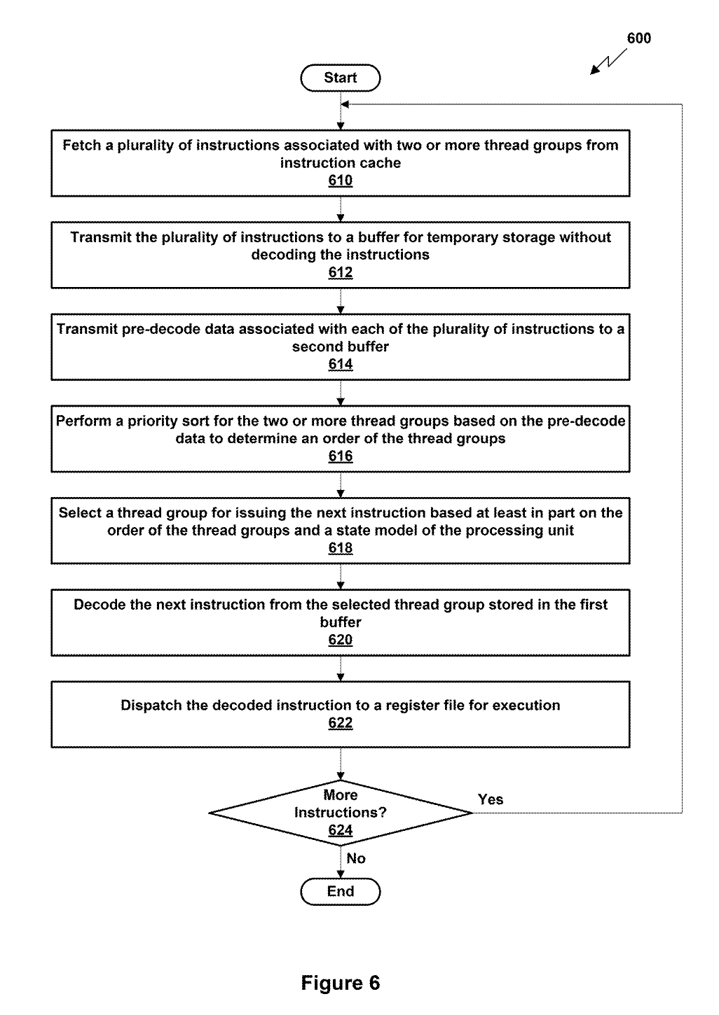

FIG. 6 illustrates a method 600 for scheduling instructions without instruction decode, according to one example embodiment of the present disclosure. Although the method steps are described in conjunction with the systems of FIGS. 1, 2, 3A-3C, 4 and 5 persons of ordinary skill in the art will understand that any system configured to perform the method steps, in any order, is within the scope of the disclosure.

Method 600 begins at step 610, where warp scheduler and instruction unit 312 fetches a plurality of instructions associated with two or more thread groups from instruction L1 cache 370. Each fetch may retrieve a cache line containing a number of distinct instructions stored in the same cache line. In one embodiment, the first instruction of the cache line is a special instruction (ss-inst) 510 that includes the pre-decode data for the other instructions stored in the cache line. At step 612, the warp scheduler and instruction unit 312 stores the instructions in IFB 422 within the warp scheduler and instruction unit 312. At step 614, the warp scheduler and instruction unit 312 transmits pre-decode data to IPB 424. In one embodiment, the pre-decode data is generated by performing a partial decode of the instruction. In another embodiment, the pre-decode data is read from a special instruction included in the cache line. In yet another embodiment, the pre-decode data may be read from a special location in memory.

At step 616, a macro-scheduler unit 420 included in the warp scheduler and instruction unit 312 performs a priority sort based at least in part on the pre-decode data to determine an order of the two or more thread groups. In one embodiment, warp scheduler and instruction unit 312 may manage up to sixteen different thread groups for parallel execution. The order of the thread groups represents the priority of each thread group for scheduling decisions. The macro-scheduler unit 420 may assign a 6-bit priority value to each of the thread groups. Macro-scheduler unit 420 sorts the pre-decode data in IPB 422 into warp FIFO 442 according to the thread group priority values, generating an order of the thread groups. At step 618, a micro-scheduler arbiter 440 included in the warp scheduler and instruction unit 312 selects a thread group for execution based at least in part on the order of the thread groups and a state model of SM 310 maintained by the micro-scheduler arbiter 440. The state model of SM 310 enables micro-scheduler arbiter 440 to determine an adjustment to the priority of particular thread groups based on resource availability and other criteria.

At step 620, decode unit 450 included in the warp scheduler and instruction unit 312 decodes the selected instruction for execution on SM 310. In one embodiment, decode unit 450 may implement two or more separate and distinct logic blocks for decoding multiple instructions in parallel. At step 622, dispatch unit 470 transmits the decoded instructions to local register file 304 for execution by the functional units of SM 310. At step 624, warp scheduler and instruction unit 312 determines whether there are more pending instructions in IFB 422. If there are more pending instructions, then method 600 returns to step 610 and another instruction is selected for execution. However, if there are no pending instructions in IFB 422, then method 600 terminates.

One advantage of the disclosed system is that the decode unit only decodes the next instruction that is to be scheduled, reducing latencies introduced by waiting until a plurality of instructions have been decoded before determining which instruction to schedule. Another advantage of the disclosed system is that performing a priority sort with the macro-scheduler unit prior to adjusting the order of the thread groups with the micro-scheduler arbiter greatly reduces the amount of logic needed to implement the scheduling algorithm, requiring only a quick tree traversal of the sorted thread groups to determine the highest priority instruction ready to be dispatched.

One embodiment of the disclosure may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The disclosure has been described above with reference to specific embodiments. Persons of ordinary skill in the art, however, will understand that various modifications and changes may be made thereto without departing from the broader spirit and scope of the disclosure as set forth in the appended claims. The foregoing description and drawings are, accordingly, to be regarded in an illustrative rather than a restrictive sense.

What is claimed is:

1. A method for scheduling instructions without instruction decode, the method comprising:
fetching a plurality of instructions corresponding to two or more thread groups from an instruction cache unit, wherein each thread group includes one or more threads;
storing the plurality of instructions in a buffer without decoding the plurality of instructions;
receiving pre-decode data associated with each of the instructions in the plurality of instructions;
selecting an instruction from the plurality of instructions for execution by a processing unit based at least in part on the pre-decode data;
decoding the instruction; and
dispatching the instruction to the processing unit for execution.

2. The method of claim 1, wherein selecting the instruction comprises:
performing a priority sort of the two or more thread groups based on the pre-decode data to determine an order of the two or more thread groups; and
selecting the instruction as the next pending instruction from the highest thread group in the order.

3. The method of claim 2, wherein selecting the instruction further comprises adjusting the order based on a state model of the processing unit.

4. The method of claim 3, further comprising updating the state model in response to dispatching the instruction.

5. The method of claim 1, wherein the pre-decode data is generated by partially decoding the associated instruction.

6. The method of claim 1, wherein the pre-decode data is included in a separate instruction in the same cache line as the associated instruction.

7. The method of claim 1, further comprising:
selecting a second instruction from the plurality of instructions for execution by the processing unit in parallel with the instruction;
decoding the second instruction; and
dispatching the second instruction to the processing unit for execution in parallel with the instruction.

8. A computer-readable storage medium including instructions that, when executed by a processing unit, cause the processing unit to perform the steps of:
fetching a plurality of instructions corresponding to two or more thread groups from an instruction cache unit, wherein each thread group includes one or more threads;
storing the plurality of instructions in a buffer without decoding the plurality of instructions;
receiving pre-decode data associated with each of the instructions in the plurality of instructions;
selecting an instruction from the plurality of instructions for execution by a processing unit based at least in part on the pre-decode data;
decoding the instruction; and
dispatching the instruction to the processing unit for execution.

9. The computer-readable storage medium of claim 8, wherein selecting the instruction comprises:
performing a priority sort of the two or more thread groups based on the pre-decode data to determine an order of the two or more thread groups; and
selecting the instruction as the next pending instruction from the highest thread group in the order.

10. The computer-readable storage medium of claim 9, wherein selecting the instruction further comprises adjusting the order based on a state model of the processing unit.

11. The computer-readable storage medium of claim 10, further comprising updating the state model in response to dispatching the instruction.

12. The computer-readable storage medium of claim 8, wherein the pre-decode data is generated by partially decoding the associated instruction.

13. The computer-readable storage medium of claim 8, wherein the pre-decode data is included in a separate instruction in the same cache line as the associated instruction.

14. A system for scheduling instructions without instruction decode, the system comprising:
a central processing unit (CPU); and
a parallel processing unit that includes a scheduling unit configured to:
fetch a plurality of instructions corresponding to two or more thread groups from an instruction cache unit, wherein each thread group includes one or more threads,
store the plurality of instructions in a buffer without decoding the plurality of instructions,
receive pre-decode data associated with each of the instructions in the plurality of instructions,
select an instruction from the plurality of instructions for execution by the parallel processing unit based at least in part on the pre-decode data,
decode the instruction, and
dispatch the instruction to the parallel processing unit for execution.

15. The system of claim 14, wherein the scheduling unit includes a macro-scheduling unit configured to perform a priority sort of the two or more thread groups based on the pre-decode data to determine an order of the two or more thread groups.

16. The system of claim 15, wherein the scheduling unit further includes a micro-scheduling unit configured to adjust the order based on a state model of the processing unit.

17. The system of claim 16, wherein the micro-scheduling unit is further configured to update the state model in response to dispatching the instruction.

18. The system of claim 14, wherein the pre-decode data is generated by partially decoding the associated instruction.

19. The system of claim 14, wherein the pre-decode data is included in a separate instruction in the same cache line as the associated instruction.

20. The system of claim 14, wherein the scheduling unit includes a first decode unit configured to decode the instruction and a second decode unit configured to decode a second instruction from the plurality of instructions for execution by the processing unit in parallel with the instruction.
